(19) United States
(12) Patent Application Publication
(10) Pub. No.: US 2016/0363153 A1
(43) Pub. Date: Dec. 15, 2016

(54) Fastener Systems for Enclosures

(71) Applicant: Hoffman Enclosures, Inc., Anoka, MN (US)

(72) Inventors: Harold D. Lakoduk, Ramsey, MN (US); Csaba Andrasfi, Oakdale, MN (US); Nathan L. Westby, Zimmerman, MN (US)

(21) Appl. No.: 15/176,988

(22) Filed: Jun. 8, 2016

Related U.S. Application Data
(60) Provisional application No. 62/173,112, filed on Jun. 9, 2015.

(51) Int. Cl. F16B 37/04; F16B 35/00

(52) U.S. Cl. CPC F16B 37/044; F16B 37/045; F16B 35/00

(57) ABSTRACT

Embodiments of the invention provide a fastener system for securing a component to an enclosure member. A mounting cage can include a flange and a cage portion with a blocking feature. In an installation configuration, a threaded fastener extends through the flange to engage the nut, and the blocking feature blocks translation of the nut along the cage portion towards the flange. In a fastening configuration, the nut can be rotated to clear the blocking feature, and the threaded fastener can be rotated to translate the nut along the cage portion

### RELATED APPLICATIONS

This application claims priority to U.S. Provisional Patent Application No. 62/173,112, which was filed on Jun. 9, 2015.

### BACKGROUND

Conventional enclosures include different support members for holding and protecting electronic devices and other components. In order to customize the configuration of an enclosure, fasteners can be used to attach different components to the support members at different locations. For example, a conventional cage nut can include a cage within which a nut is configured to travel. With the cage inserted in a mounting opening on an enclosure, the nut can be tightened to secure a component at the mounting opening.

### SUMMARY

Some embodiments of the invention provide a fastener assembly for securing an object to a structure. A mounting cage can include a cage portion and a flange attached to the cage portion at a first end of the cage portion, with the cage portion including a first cage side with a first cage channel, and a second cage side with a first blocking feature. A threaded fastener can be disposed through the cage portion. A nut can be elongate in a first dimension, and can threadedly engage the threaded fastener within the cage portion. The fastener assembly can have an installation configuration in which the nut is in a first orientation so that the first blocking feature blocks translation of the nut along the cage portion towards the flange and the cage portion is insertable through both a first mounting opening in the object and a second mounting opening in the structure. The fastener assembly can have a fastening configuration in which the nut is rotated from the first orientation to a second orientation so that the nut is clear of the blocking feature and rotation of the threaded fastener translates the nut along the first cage channel towards the flange and clamps the object and the structure between the flange and the nut.

Some embodiments of the invention provide fastener system, for use with a nut that has a nut width and a nut height larger than the nut width, to secure an object that has a first mounting opening to a structure that has a second mounting opening. A mounting cage can include a flange and a cage portion. The cage portion can have a blocking feature, a first cage side with a first insertion opening, and a second cage side with a cage channel. The first insertion opening can be sized for the nut to be inserted through the first insertion opening into the cage portion with the nut in a first orientation.

The blocking feature can block translation of the nut along the cage portion towards the flange, when the nut is in the first orientation. The cage channel can guide translation of the nut along the cage portion towards the flange, when the nut is rotated to a second orientation different from the first orientation.

Some embodiments of the invention provide a method for securing an object to a structure using a cage nut assembly, where the object includes a first mounting opening, the structure includes a second mounting opening aligned with the first mounting opening, and the cage nut assembly includes a threaded fastener, a nut, and a mounting cage, with the mounting cage including a flange and a cage portion with a blocking feature, and with the threaded fastener, the mounting cage, and the nut being initially assembled into a unitary assembly with an insertion configuration in which the threaded fastener extends through the flange to engage the nut, a perimeter of the nut is disposed substantially within a perimeter of the cage portion, and the blocking feature blocks the nut from translating along the cage portion towards the flange. The unitary assembly can be inserted into the first mounting opening and the second mounting opening until the nut and a part of the cage portion are disposed on a first side of the object and the structure, and the flange is disposed on a second side of the object and the structure. The threaded fastener can be rotated from the first side of the object and the structure to rotate the nut so that the perimeter of the nut extends outside the perimeter of the cage. The threaded fastener can be further rotated to translate the nut along the cage towards the flange until the object and the structure are clamped between the nut and the flange.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front, top, right isometric view of a mounting cage for use with a cage nut fastener system, according to one embodiment of the invention;

FIG. 2 is a front, top, right isometric view of a nut for use in the cage nut fastener system with the mounting cage of FIG. 1, according to one embodiment of the invention;

FIG. 3 is a front, top, right isometric view of a screw for use in the cage nut fastener system with the mounting cage of FIG. 1 and the nut of FIG. 2;

FIG. 4 is a front, top, right isometric view of the cage nut fastener system according to one embodiment of the invention, including the mounting cage of FIG. 1, the nut of FIG. 2, and the screw of FIG. 3, at the start of an installation of the cage nut fastener system on an enclosure frame;

FIG. 5 is a front, top, right isometric view of the cage nut fastener system of FIG. 4, later in time during the installation;

FIG. 6 is a front, top, right isometric view of the cage nut fastener system of FIGS. 4 and 5, still later in time during the installation;

FIG. 7 is a front, top, right isometric view of the cage nut fastener system of FIGS. 4 through 6, even later in time during the installation;

FIG. 8 is a front, top, right isometric view of multiple cage nut fastener systems installed on an enclosure frame;

FIG. 9 is a front, top, right isometric view of a screw for use in a cage nut fastener system according to one embodiment of the invention;

FIG. 10 is a front, top, right isometric view of a cage nut fastener system according to one embodiment of the invention, including the screw of FIG. 10, at the start of an installation of the cage nut fastener system on an enclosure frame;

FIG. 11 is a front, top, right isometric view of the cage nut fastener system of FIG. 10, later in time during the installation;

FIG. 12 is a front, top, right isometric view of the cage nut fastener system of FIGS. 10 and 11, still later in time during the installation;

FIG. 13 is a front, top, right isometric view of the cage nut fastener system of FIGS. 10 through 13, even later in time during the installation;

FIG. 14 is an exploded front, top, right isometric view of a cageless fastener system, according to another embodiment of the disclosure;

FIG. 15A is a front, top, right isometric view of a nut for use with the cageless fastener system of FIG. 14;

FIG. 15B is a rear, top, left isometric view of the nut of FIG. 15B;

FIG. 16 is a rear isometric view of a washer of the cageless fastener system of FIG. 14;

FIG. 17 is a front, top, right isometric view of the cageless fastener system of FIG. 14, at the start of an installation of the cageless fastener system on an enclosure frame; and

FIG. 18 is a front, top, right isometric view of the cageless fastener system of FIG. 14, with the cageless fastener system fully installed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In examples below, directional descriptions such as “front,” “back,” “top,” “bottom,” “width,” “length,” “height,” and so on are used to describe particular embodiments of the invention. Unless otherwise specified or limited, these descriptions are used only for convenience and only with respect to the particular embodiment (or orientation thereof) specifically addressed by the relevant description. Accordingly, it will be understood that some embodiments can exhibit different orientations of “top,” “bottom,” front,” “back,” and other features than those expressly discussed below.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Conventional fastener systems can include multiple loose pieces, which are transported and installed individually before being connected together to secure a component to an enclosure. For example, conventional cage nut systems can include a mounting cage, a nut and a screw, each provided separately from each other. Accordingly, to mount a component to an enclosure a user may be required to independently maneuver the mounting cage, nut, screw, and component into appropriate orientations, then hold these pieces in place while tightening the screw in the nut. This can require multiple operators for installation of heavy or otherwise unwieldy accessories, and can lead to lost fastener pieces. Further, proper installation of conventional cage nut systems can require an operator to access both sides of a mounting location (e.g., to access points that are both inside and outside of an enclosure). This may be difficult or impractical in certain applications.

Other types of conventional fastener systems can suffer from similar deficiencies, including elevated risks of losing loose pieces and the potential need for multiple operators to mount certain components. Further, in some conventional designs, mounting locations on the enclosure must be specially configured for the fastener system (e.g., formed with complex or compound geometries). This can limit flexibility with regard to the types of components that can be secured to an enclosure, as well as the number and placement of the various mounting locations.

Conventional fastener systems can also be limited to use for securing components that exhibit a narrow range of thicknesses at a mounting point. For example, conventional cage nut designs may exhibit relatively small travel ranges for the cage-mounted nuts, with corresponding limitations on the thickness of enclosures or components with which the cage nuts can be used.

Accordingly, a need exists for a fastener system that has a reduced number of loose pieces, and exhibits substantial flexibility with regard to mounting locations. A need also exists for a fastener system that can accommodate a wide range of enclosure and component thicknesses.

In some embodiments, a fastener system according to the invention can address these (or other) needs. For example, in some embodiments, a fastener system configured as a cage nut can include a cage portion and an integral flange. A nut can be inserted into the cage with the nut extending into one of two insertion openings on opposite sides of the cage portion, and with a perimeter of the nut within (i.e., even with or surrounded by) a perimeter of the cage portion. A screw (or other threaded fastener) can then be inserted through the flange to engage the nut, so that the screw, the nut, and the cage form a single piece, unitary assembly.

With the screw, the nut, and the cage assembled together, the flange on the cage can prevent a head of the screw from moving axially into the cage portion. Accordingly, rotating the screw to advance the nut can urge the nut towards the flange, while the screw remains axially stationary. As the nut is urged towards the flange, a blocking feature can initially block translation of the nut along the cage portion. However, the frictional engagement of the screw with the nut can eventually rotate the nut relative to the cage so that the nut clears the blocking feature. With further rotation of the screw, the nut can then be advanced along the cage towards the flange, to clamp together two objects (e.g., an enclosure frame member and an enclosure component) of a variety of thickness.

In some embodiments, a length of the nut in the insertion direction can be substantially equal to a height of the cage portion at the insertion openings. Accordingly, in some embodiments, the nut can be disposed within both of the insertion openings with a perimeter of the nut substantially flush with a perimeter of the cage portion along the insertion openings.

In some embodiments, a substantially rectangular cage nut can include two blocking features formed as the forward walls of two insertion openings, with the insertion openings opening into respective cage channels that extend along opposite sides of the cage portion. Accordingly, in some embodiments, translation of a nut towards a flange can be initially blocked by side walls of the insertion openings Once the screw has rotated the nut out of the insertion openings, however, the nut can be translated towards the flange, as guided by the cage channels.

In other embodiments, other configurations are possible. For example, a fastener system according to the invention can be configured as a cage-less fastener, with spring-biased components.

In the discussion herein, some examples relate specifically to the use of fastener systems to secure components to frame members of enclosures. In other embodiments, the disclosed fastener systems can be used in a variety of other settings to connect two or more objects or structures together.

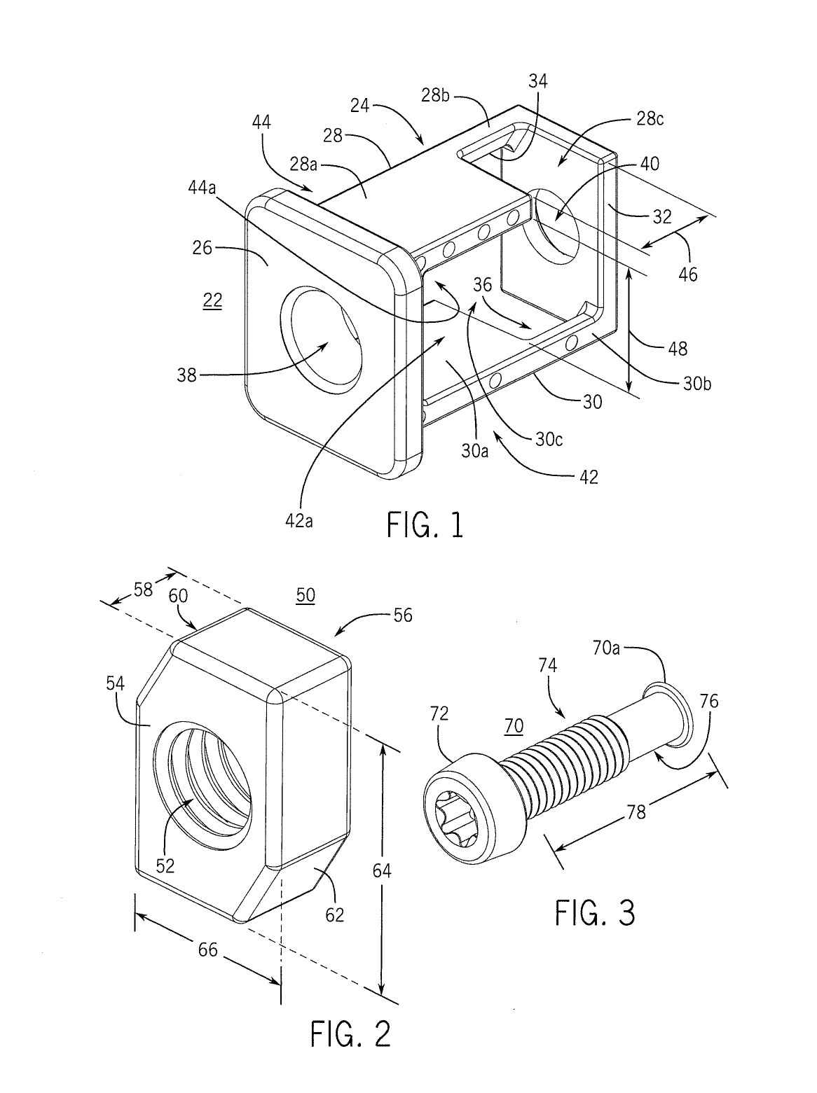

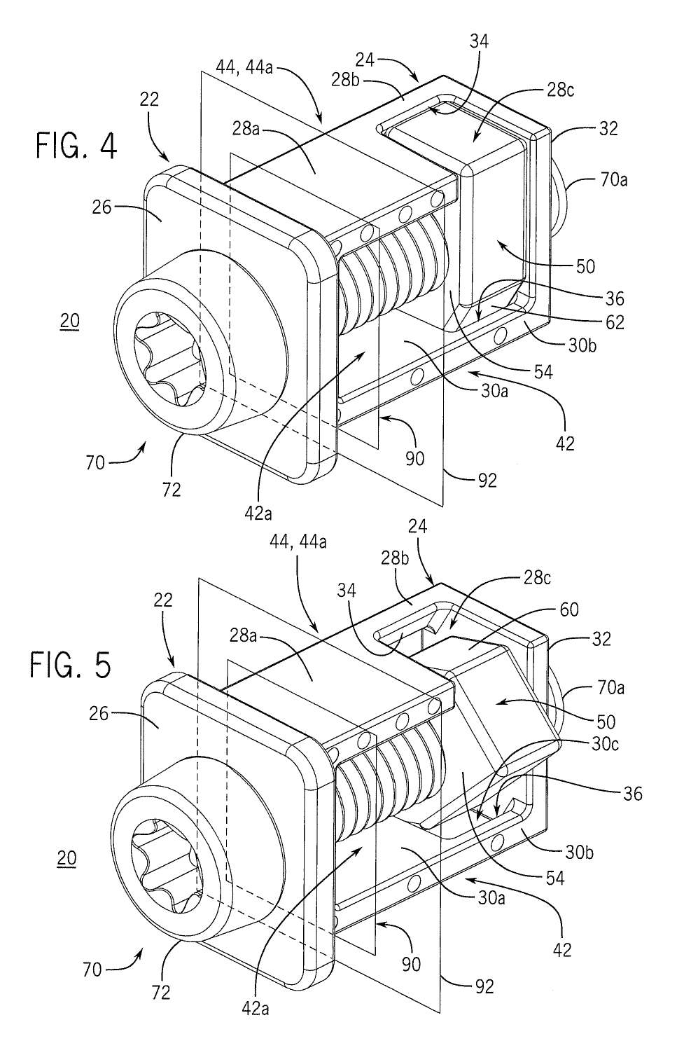

FIG. 1 illustrates a mounting cage 22 for a cage nut fastener system 20 (see FIG. 4) according to one embodiment of this disclosure. The mounting cage 22 includes an extended rectangular cage portion 24, which is attached at one end to a mounting flange 26. Generally, the mounting flange 26 exhibits a larger height and width than the cage portion 24, such that a perimeter of the mounting 27 flange extends generally beyond a perimeter of the cage portion 24. The cage portion 24 and the mounting flange 26 can be formed integrally with each other, or can be formed separately (including in respective sets of multiple pieces) and assembled for use.

The cage portion 24 includes an upper support 28 and a lower support 30, which respectively exhibit walls 28a and 30a extending from the mounting flange 26 towards a rear wall 32, and struts 28b and 30b extending between the walls 28a and 30a, respectively, and the back wall 32. Central apertures 38 and 40 are provided in the mounting flange 26 and the back wall 32, respectively.

The walls 28a and 30a of the upper and lower supports 28 and 30 generally exhibit a width equal to the total width of the cage portion 24 of the mounting cage 22. The struts 28b and 30b generally exhibit a width that is somewhat smaller than the width of the walls 28a and 30a, such that respective openings 28c and 30c are provided in the cage portion 24 of the mounting cage 22. In the embodiment illustrated, the struts 28b and 30b are configured with bevels 34 and 36 that generally face the interior of the cage portion 24. In some other embodiments, similarly disposed (or other) struts can be un-beveled.

The sides 42 and 44 of the cage portion 24 are generally open between the mounting flange 26 and the back wall 32. As such, the sides 42 and 44 of the cage portion 24 generally defining respective rectangular channels 42a and 44a. In the embodiment illustrated, the sides 42 and 44 are entirely open (i.e., the channels 42a and 44a extend fully along the cage portion 24). Accordingly, the upper and lower walls 28a and 30a are connected to each other only via the mounting flange 26 and the back wall 32 (by way of the struts 28b and 30b). In other embodiments, other configurations are possible.

FIG. 2 illustrates a nut 50 for use with the mounting cage 22. A bore 52 is provided between front and rear faces 54 and 56 of the nut 50. The bore 52 can be threaded (not shown) to engage any number of screw-thread configurations and the front and rear faces 54 and 56 can include a bevel at upper and lower ends, as appropriate. In the embodiment illustrated, the nut 50 further includes bevels 60 and 62, which can exhibit a similar bevel angle as the bevels 34 and 36 of the mounting cage 22.

The nut 50 generally exhibits a depth 58 that is generally equal to or less than a depth 46 of the openings 28c and 30c of the mounting cage 22 (see FIG. 1). Accordingly, as also described below, the nut 50 can be inserted into the interior of the cage portion 24 of the mounting cage 22 to extend into the openings 28c and 30c, with the nut 50 and the mounting cage 22 in approximately the orientations illustrated in FIGS. 1 and 2. In the embodiment illustrated, a height 64 of the nut 50 is somewhat larger than a width 66 of the nut 50 (i.e., the nut 50 is generally elongate along the direction of the height 64). Further, the height 64 is generally larger, and the width 66 is generally smaller, than a distance 48 between the upper and lower walls 28a and 30a of the mounting cage 22 (see FIG. 1). Accordingly, the nut generally can translate along the channels 42a and 44a when the width 66 is square to the walls 28a and 30a. However, when the height 64 is square to the walls 28a and 30a, the forward walls of the openings 28c and 30c bloc the nut 50 from translating along the cage portion 24.

FIG. 3 illustrates a screw 70 for use with the nut 50 and the mounting cage 22. As illustrated, the screw 70 is a socket head screw that includes a hexalobular internal (i.e., “star”) head 72. In other embodiments, a button-head screw, tap-head screw or other threaded fastener type can be used, including a threaded fastener with a textured (e.g., ridged or knurled) head. The screw 70 includes a threaded shaft 74 with a length 78 that is at least as long as the total depth of the mounting cage 22 (i.e., at least as long as the distance between the front face of the mounting flange 26 and the back face of the back wall 32).

In the embodiment illustrated, the shaft 74 can include a non-threaded portion 76 that is generally disposed near an end 70a of the screw 70. In other embodiments, a screw (or other threaded fastener) may include no non-threaded portion, or a non-threaded portion in a different location. Also in the embodiment illustrated, the end 70a of the screw 70 is peened to exhibit a wider diameter than the remainder of the shaft 74. In some embodiments, the end 70a of the screw can be peened (or otherwise widened) after assembly of the fastener system 20 (e.g., as described below).

FIG. 4 illustrates the cage nut fastener system 20 assembled into a unitary assembly and arranged in an installation configuration. To assemble the fastener system 20, the nut 50 can be inserted into the mounting cage 22, via one of the openings 28c and 30c in the cage portion 24, until the perimeter of the nut 50 is substantially within the perimeter of the cage portion 24. In some embodiments, for example, the nut 50 can be disposed substantially within both of the openings 28c and 30c, with the length of the nut 50 extending generally between the openings 28c and 30c. As the nut 50 is inserted through the opening 28c or 30c, the bevels 60 and 62 on the nut 50 and the bevels 34 and 36 on the struts 28a and 28b can help to properly align the nut 50 with the cage portion 24 of the mounting cage 20. With the nut 50 in place within the cage portion 24, the screw 70 (before being peened) can be inserted through the central aperture 38 of the mounting cage 22, the bore 52 of the nut 50, and the central aperture 40 of the mounting cage 22.

In some embodiments, once the cage nut fastener assembly 20 has been assembled, the end 70a of the screw 70 can be widened by peening (see FIG. 3) or other processes, so as to prevent retraction of the screw 70 out of the central aperture 40. Further, contact of the screw head 72 with the mounting flange 26 prevents the screw 70 from moving in the opposite direction past the mounting flange 26. Accordingly, the screw 70, the nut 50, and the mounting cage 22 are retained together as a unitary assembly for transport and installation. Due to its unitary assembled configuration, and as also discussed below, the fastener system 20 can also be installed onto a structure without the need to access both sides of the structure. For example, the fastener system 20 can be installed to hold a component to an enclosure member without the need to access an interior of the relevant enclosure.

In order for the fastener system 20 to secure an object (e.g., a component for an enclosure) to a structure (e.g., an enclosure member), a mounting opening can be provided in both the enclosure member and the component. Generally, mounting openings can be somewhat larger in height and width than the cage portion 24 of the mounting cage 22, but somewhat smaller in height and width than the mounting flange 26, so that the cage portion 24 can be moved through the mounting openings but the mounting flange 26 cannot. As illustrated in FIG. 4, for example, a rectangular mounting opening 90 in an enclosure member 92 is large enough to receive the cage portion 24 of the mounting cage 22, and also small enough to prevent passage of the mounting flange 26 through the mounting opening 90. A similarly scaled mounting opening can also be provided in an enclosure component (not shown) that is to be mounted to the enclosure member 92.

Before the fastener system 20 can be installed, the mounting opening in the component to be mounted to the enclosure member 92 can be generally aligned with the mounting opening 90. The cage portion 24 of the mounting cage 22 can then inserted through the mounting opening in the component as well as the mounting opening 90 of the enclosure member 92 until the mounting flange 26 is seated against the enclosure member 92 (directly or indirectly) or the component (directly or indirectly). With the fastener system 20 thus disposed, and as also described below, the fastener system 20 can be actuated to clamp the component (or components) and the enclosure member 92 between the nut 50 and the mounting flange 26.

In some embodiments a cage portion of a mounting cage can include a blocking feature that blocks a nut from translating towards a flange when the nut is in a first orientation (e.g., in an installation configuration), but permits the nut to translate towards the flange when the nut is in a second orientation (e.g., in a fastening configuration). In the embodiment illustrated, for example, the height 64 of the nut 50 (see FIG. 2) is selected so that the nut 50 can extend into both of the openings 28c and 30c, when the nut 50 is inserted into the mounting cage 22 and the fastener system 20 is in the installation configuration (see FIG. 4). Accordingly, when the nut 50 is first inserted into the mounting cage 22 via the openings 28c and 30c, the edges of the upper and lower walls 28a and 30a that bound the openings 28c and 30c (i.e., the forward walls of the openings 28c and 30c) act as blocking features to prevent the nut 60 from moving along the cage portion 26 towards the mounting flange 26.

It will be understood that a fastener system can be placed in an “installation” configuration during installation of the fastener system, as well as at other times. For example, the fastener system 20 can be placed in the installation configuration illustrated in FIG. 4 when the fastener system 20 is to be uninstalled (e.g., withdrawn out of the mounting opening 90 and any other mounting openings), as well as when the fastener system 20 is about to be, or has just been, installed.

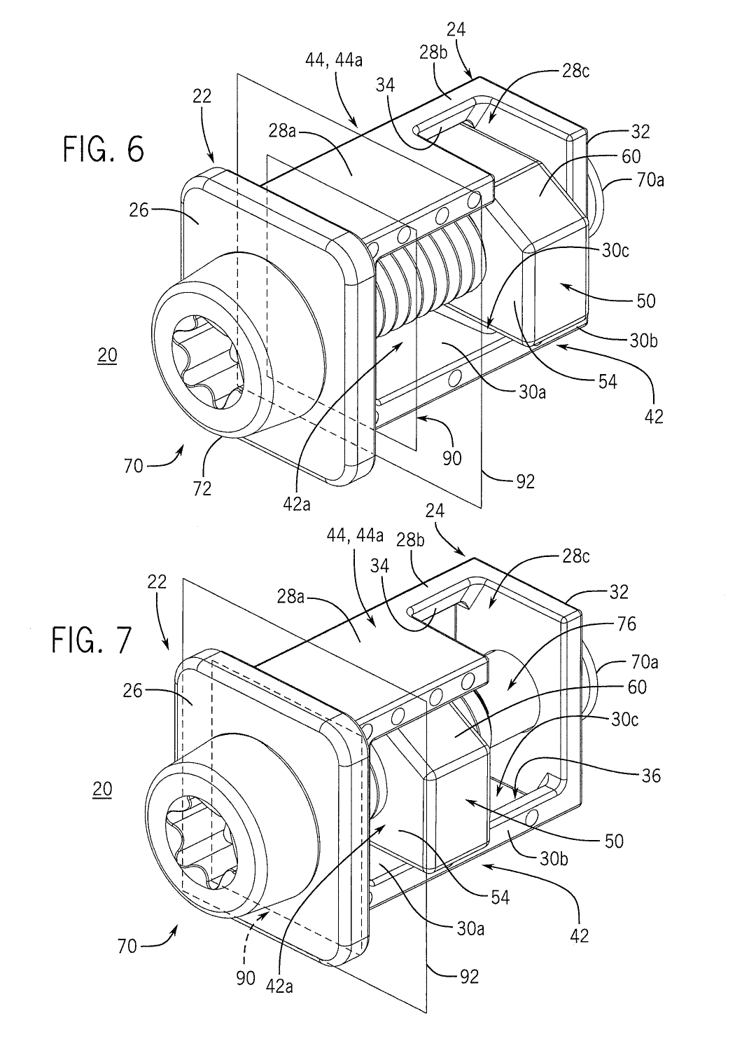

From the configuration illustrated in FIG. 4, and as illustrated in particular in FIG. 5, tightening the screw 70 (e.g., rotating the screw 70 in a clockwise direction) can cause the nut 50 to rotate in a corresponding (e.g., clockwise) direction. As noted above, this can be facilitated in some embodiments by the clearance between the bevels 34 and 36 on the mounting cage 22 and the bevels 60 and 62 on the nut 50. With sufficient tightening of the screw 70, as illustrated in FIG. 6, the nut 50 can be rotated approximately 90 degrees from its orientation in FIG. 4. This can cause opposite sides of the nut 70 to contact the struts 28b and 30b of the upper and lower supports 28 and 30, such that further clockwise rotation of the nut 50 by the screw 70 is prevented.

In such an orientation of the nut 50, because the nut width 66 is generally smaller than the distance 48 between the upper and lower supports 28 and 30 (see FIG. 1), the nut 50 is clear of the upper and lower walls 28a and 30a, so that the forward walls of the openings 28c and 30c no longer block translational movement of the nut towards the mounting flange 26. Accordingly, further tightening of the screw 70 can cause the nut 70 to move along the channels 42a and 44a of mounting cage 22 towards the mounting flange 26 (see FIG. 7). With appropriate tightening of the screw 70, the nut 50 can therefore clamp the enclosure member 92 and a component (or components) to be attached thereto (not shown) between the nut 50 and the mounting flange 26, so that the cage nut fastener system 20 and the component(s) are both held in place with respect to the enclosure member 92.

For convenience of presentation, the enclosure member 92 is shown with minimal thickness and the component to be attached thereto is not illustrated. It will be understood, however, that different enclosure members and components may have different thicknesses. Usefully, because of the relatively large potential travel distance for the nut 50 (i.e., the relatively large distance along the channels 42a and 44a), a large variety of thicknesses of enclosure members and components can be accommodated by the fastener system 20.

In some embodiments, other features can be included. For example, one or more spikes or nubs (not shown) can be included on the front face 54 of the nut 50. When the nut 50 is tightened during installation, these spikes or nubs can penetrate a painted coating on the relevant body (e.g., the enclosure member 92) in order to contact the underlying metal of the body and thereby provide electrical bonding. Various sealing bodies such as gaskets (not shown) can also be provided, including between the mounting flange 26 and the head 72 of the screw 70, and between the mounting flange 26 and the enclosure member 92 or component to be mounted thereto.

In some embodiments, other configurations are possible. In some embodiments, for example, a blocking feature can be provided (or supported) by a structure other than the walls 28a and 30a. Similarly, in some embodiments, the channels 42 and 44a can be configured to extend only part way between the mounting flange 26 and the back wall 32.

As also noted above, the screw 70 includes the non-threaded portion 76 near the end 70a. In some embodiments, this can help to prevent inadvertent damage to the cage portion 24 of the mounting cage 22. As illustrated in FIG. 7, for example, when the screw 70 secures the nut 50 to the mounting cage 22, the non-threaded portion 76 of the screw 70 is generally aligned with the openings 28c and 30c. Accordingly, with the fastener system 20 in the installation configuration (see, e.g., FIG. 4), the threads of the screw 70 may engage the nut 50 only minimally (or, in some cases, not at all). Accordingly, when the nut is being moved from the fastening configuration (e.g., as in FIG. 7) to the installation configuration (e.g., as in FIG. 4), the disposition of the non-threaded portion 76 can help to prevent the nut 50 from being over-rotated (e.g., strongly rotated into the struts 28b and 30b), and thereby prevent damage to the struts 28b and 30b and the cage portion 24 generally.

In some embodiments, the screw 70 can be configured so that the threads of the screw 70 engage the nut 50 when the nut 50 is within the openings 28c and 30c and the head 72 of the screw is seated against the flange 26, but do not engage the nut 50 when the nut 50 is within the openings 28c and 30c and the peened end 70a of the screw is seated against the rear wall 32. Accordingly, with the nut 50 within the openings 28c and 30c, the screw 70 can be used to rotate the nut 50 when the head 72 of the screw 70 is pressed against the flange 72, but the screw 70 cannot be used to rotate the nut 50 when the peened end 70a of the screw 70 is pressed against the rear wall 32. In this way, for example, the non-threaded portion 76 of the screw 70 can prevent the screw 70 from over-rotating the nut 50 when the fastener system 20 is being moved to the installation configuration, but can allow the screw 70 to engage the nut 50 for rotation when the fastener system 20 is being moved out of the installation configuration.

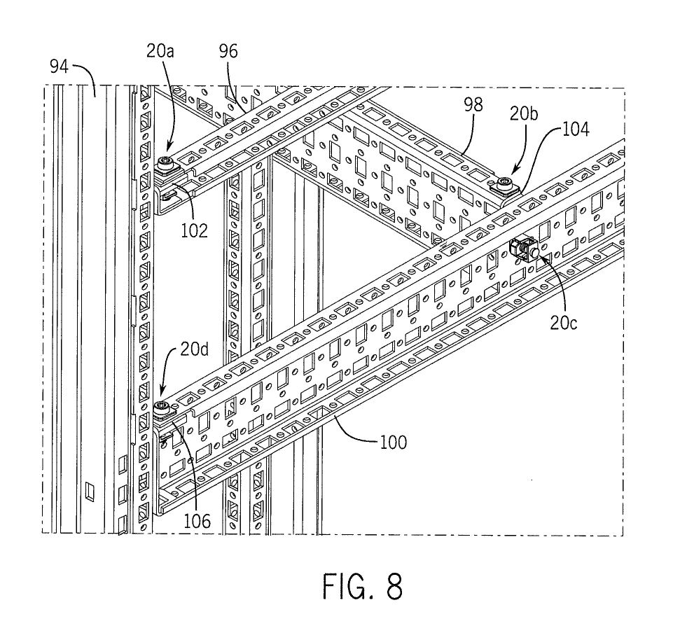

FIG. 8 illustrates a part of an enclosure frame 94 with various grid straps 96, 98, and 100. The grid straps 96, 98, and 100 are provided with rectangular mounting openings configured to receive the cage portion 24 of the mounting cage 22. Various cage nut fastener systems 20a, 20b, 20c, and 20d can accordingly be used, with appropriate brackets 102, 104 and 106, in order to secure the grid straps 96, 98, and 100 to each other and to the frame 94. In some cases, multiple cage nut fastener systems 20 can be used in combination to secure particular components together. For example, the cage nut fastener systems 20b and 20c can be used, respectively, to secure the bracket 104 to the grid strap 98 and to the grid strap 100. The brackets 102, 104, and 106 are illustrated in FIG. 8 as conventional u-shaped mounting brackets with rectangular mounting openings configured to receive the various cage portions 24 of the cage nut fastener systems 20a, 20b, 20c, and 20d. In other embodiments, other brackets can also (or alternatively) be used.

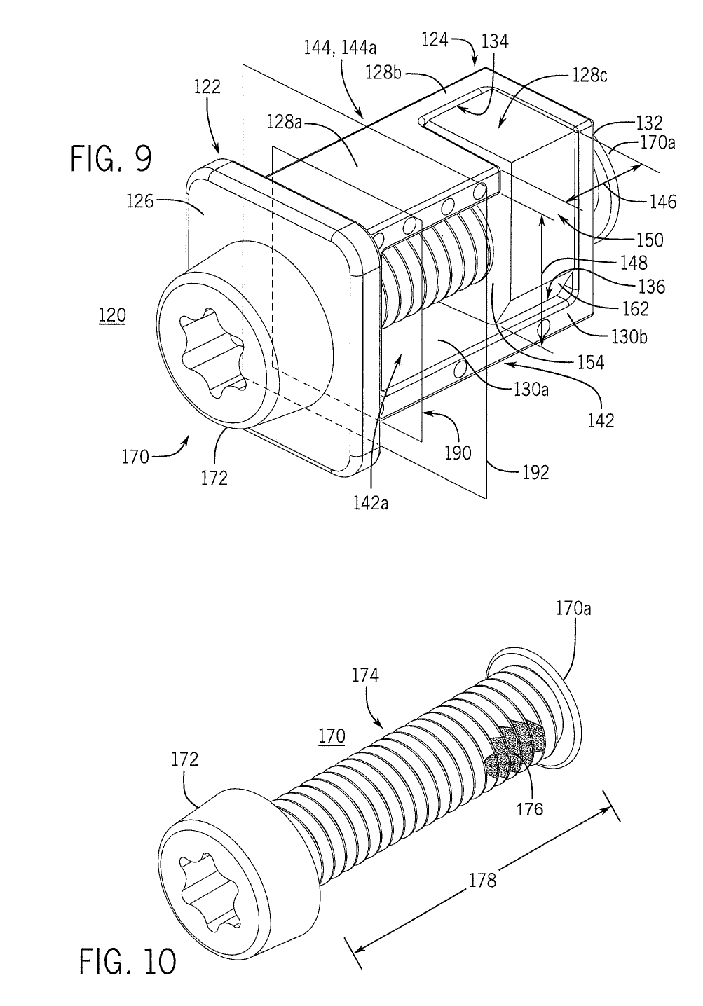

FIG. 9 illustrates a cage nut fastener system 120 that is generally configured similarly to the cage nut fastener system 20 (see, e.g., FIGS. 4 through 7). Accordingly, components of the cage nut fastener system 120 that are similar to components of the cage nut fastener system 20 are annotated in the figures with similar references numbers increased by 100. For example, whereas the cage nut fastener system 20 generally includes the mounting cage 122, the nut 50, and a threaded fastener configured as the screw 70, the cage nut fastener system 120 generally includes a mounting cage 122, a nut 150, and a threaded fastener configured as a screw 170.

Although the cage nut fastener system 120 is generally similar to the cage nut fastener system 20, certain components and functionality can differ between the cage nut fastener systems 20 and 120. As illustrated in FIG. 10, for example, the screw 170 is a socket head screw that includes a star head 172, similar to the screw 70 (see, e.g., FIG. 3). Also similar to the screw 70, the screw 170 includes a threaded shaft 174 with a length 178 that is at least as long as the total depth of the mounting cage 122 (i.e., at least as long as the distance between the front face of a mounting flange 126 and the rear face of a back wall 132 of the mounting cage 122). However, in contrast to the illustrated embodiment of the screw 70, the shaft 174 of the screw 170 includes a nut-engagement feature 176 that can grip the threads of the nut 150 in order to help the nut 150 to rotate with the screw 170. In some embodiments, the nut-engagement feature 176 can be configured as a nylon patch or spot that is formed or adhered onto the threads of the shaft 174.

As illustrated in FIG. 9, the cage nut fastener system 120 is generally in an installation configuration, with a height of the nut 150 aligned with openings 128c and 130c in a cage portion 124 of the mounting cage 122, with the nut 150 extending into the openings 128c and 130c, and with a perimeter of the nut 150 generally within a perimeter of the cage portion 124. In this configuration, the cage portion 124 can be extended into a rectangular mounting opening 190 in an enclosure member 192, and into a rectangular mounting opening in an enclosure component (not shown) that is to be mounted to the enclosure member 192, until a flange 126 of the mounting cage 122 is generally seated against the enclosure member 192 or the enclosure component. Also in the installation configuration of the cage nut fastener system 120, similarly to the cage nut fastener system 20, blocking features formed by side walls of the openings 128c and 130c can block the nut from translating towards the mounting flange 122.

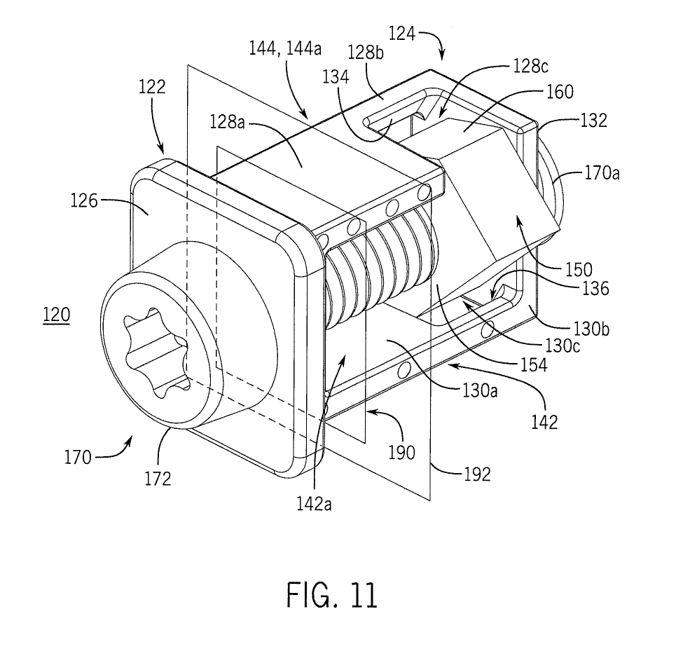

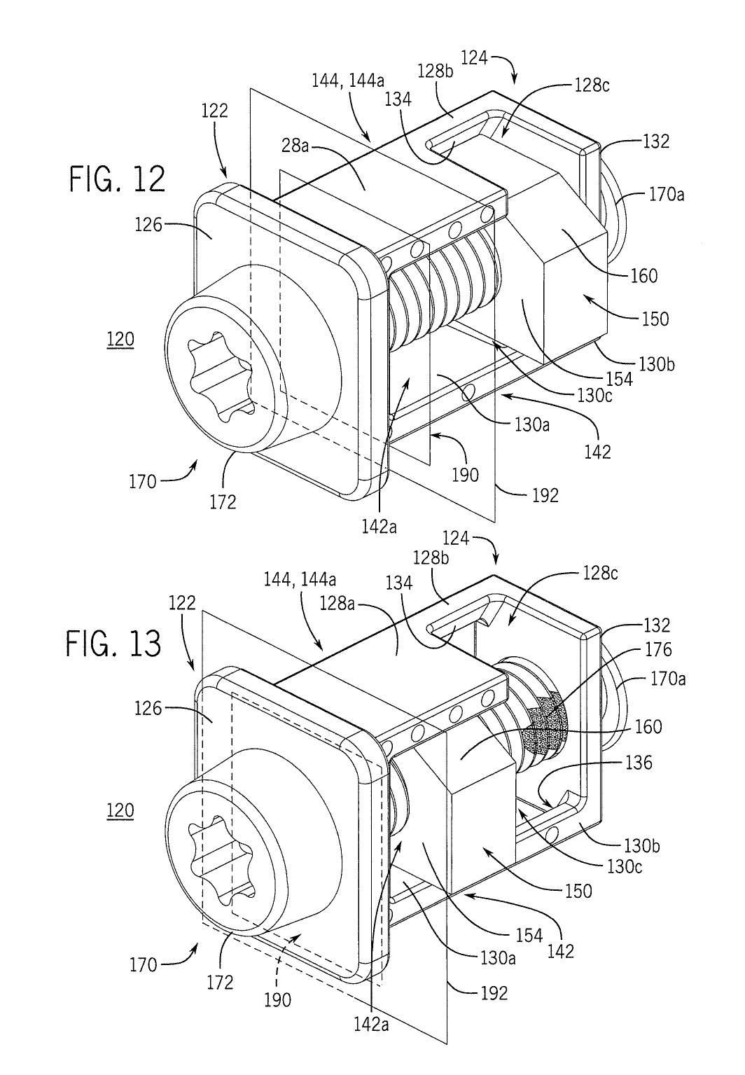

As illustrated in FIGS. 11 through 13, from the installation configuration, the screw 170 can be rotated (e.g., in a clockwise direction) so that the nut-engaging feature 176 grips the nut 150 and causes the nut 150 also to rotate (e.g., also in a clockwise direction). In this way, for example, the nut 150 can be rotated to clear the openings 128c and 130c, before rotation of the nut 150 is generally stopped by struts 128b and 130b of the cage portion 124 (e.g., despite the gripping of the nut 150 by the nut-engaging feature 176) with the cage nut fastener system 120 generally in a fastening configuration. With further rotation of the screw 170, the nut 150 can then be translated along channels 142a and 144a of the cage portion 124, in order to clamp the enclosure member 192 and the enclosure component between the nut 150 and the mounting flange 126.

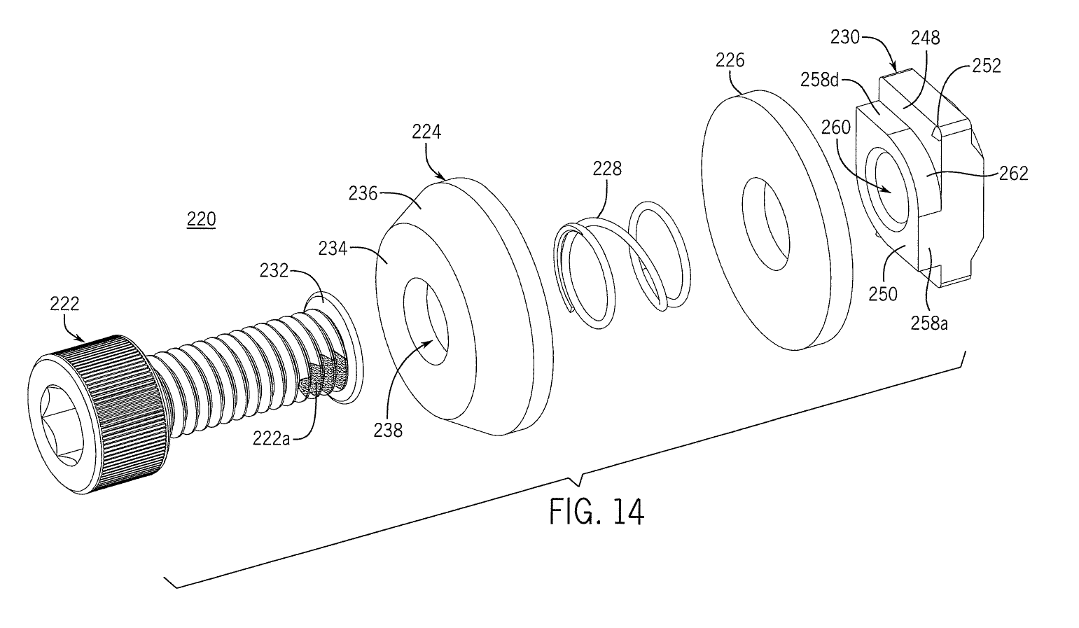

FIG. 14 illustrates an exploded view of a cageless fastener system 220 according to another embodiment of the invention. The cageless fastener system 220 includes a screw 222 configured similarly to the screw 170, washers 224 and 226, a spring 228, and a contoured nut 230. The screw 222 includes a peened contour 232 at one end, which can be formed on (or added to) the screw 222 when the cageless fastener system 220 is assembled. (For convenience of presentation, the peened contour 232 is nonetheless illustrated in the exploded view of FIG. 14.) The screw 222 can also include a nut-engagement feature, such as a nylon patch 222a.

The washer 224 includes a flattened front face 234 with a perimeter bevel 236 and a central bore 238. As illustrated in FIG. 16, a back face 240 of the washer 224 includes a counterbore 242 within which an end of the spring 228 can be seated. In some embodiments, the counterbore 242 extends to sufficient depth within the washer 224, that the spring 228, when sufficiently compressed, can be fully contained by the counterbore 242.

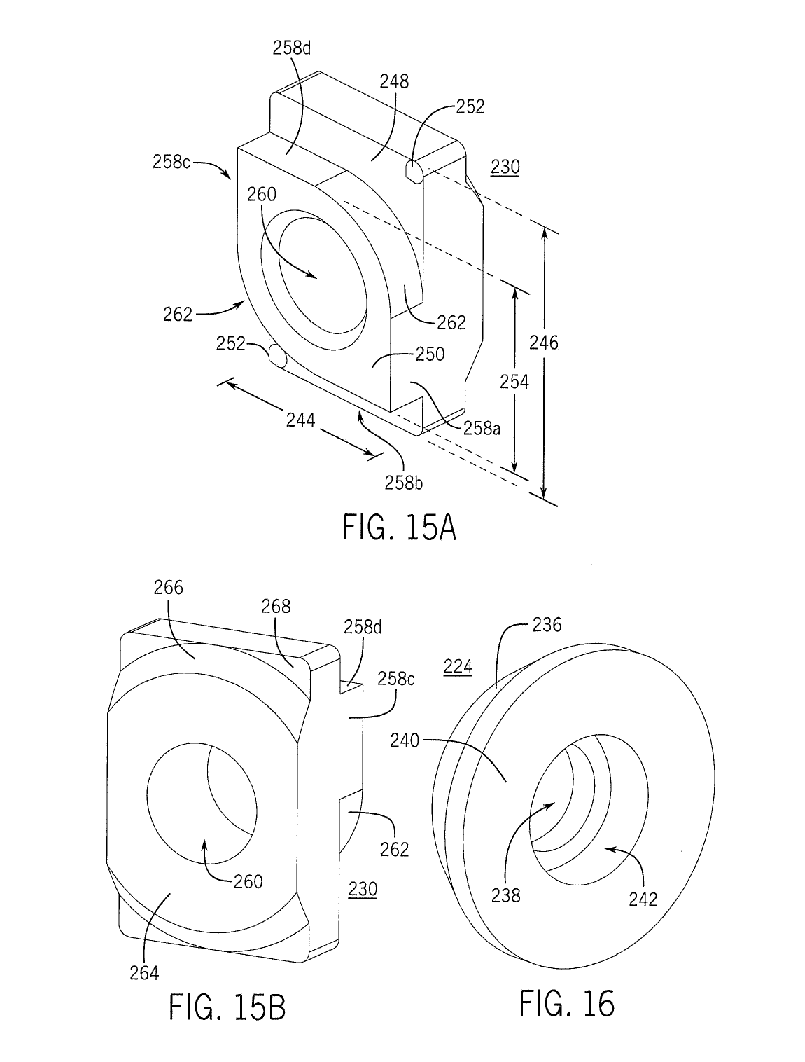

As shown in FIG. 15A, the nut 230 exhibits a width 244 and a height 246, with the width 244 being somewhat smaller than the height 246. Generally, the width 244 and height 246 can be configured for use with a rectangular mounting opening on an enclosure or other body, where the mounting opening for the enclosure or other body has a smallest dimension (e.g., a width) that is approximately equal to (or somewhat larger than) the width 244 and that is somewhat smaller than the height 246. Accordingly, with a bore 260 of the nut 230 perpendicular to such a mounting opening, the nut 230 can fit through the mounting opening when the nut 230 is in one orientation (e.g., upright, as illustrated in FIG. 15A) but may not fit through the mounting opening when the nut 230 has been rotated (about the axis of the bore 260) by 90 degrees.

The nut 230 also includes an engagement surface 248 and a locking feature 250 extending away from the engagement surface 248. The bore 260 extends through both the engagement surface 248 and the locking feature 250. In the embodiment illustrated, the engagement surface 248 includes two spikes 252 for paint-biting engagement with an enclosure or other body. In other embodiments, different (or no) features can be included on the engagement surface 248.

Generally, the locking feature 250 exhibits a height 254 that is somewhat smaller than the height 246 of the nut 230, and a maximum width that is equal to the width 244 of the nut 230. The sides of the locking feature 250 include flattened contact regions 258 connected by curved transition regions 262, and two contact regions 258a and 258b are generally aligned with the sides of the nut 230. Two contact regions 258c and 258d are separated from the top and bottom of the nut 230 by the engagement surface 248.

As illustrated in FIG. 15B, the nut 230 also includes a flattened rear face 264 with a perimeter bevel 266 and a shoulder 268. The rear face 264 can be configured to engage the back of the peened contour 232 of the screw 222 (see FIG. 14) to retain the screw 222 within the bore 260.

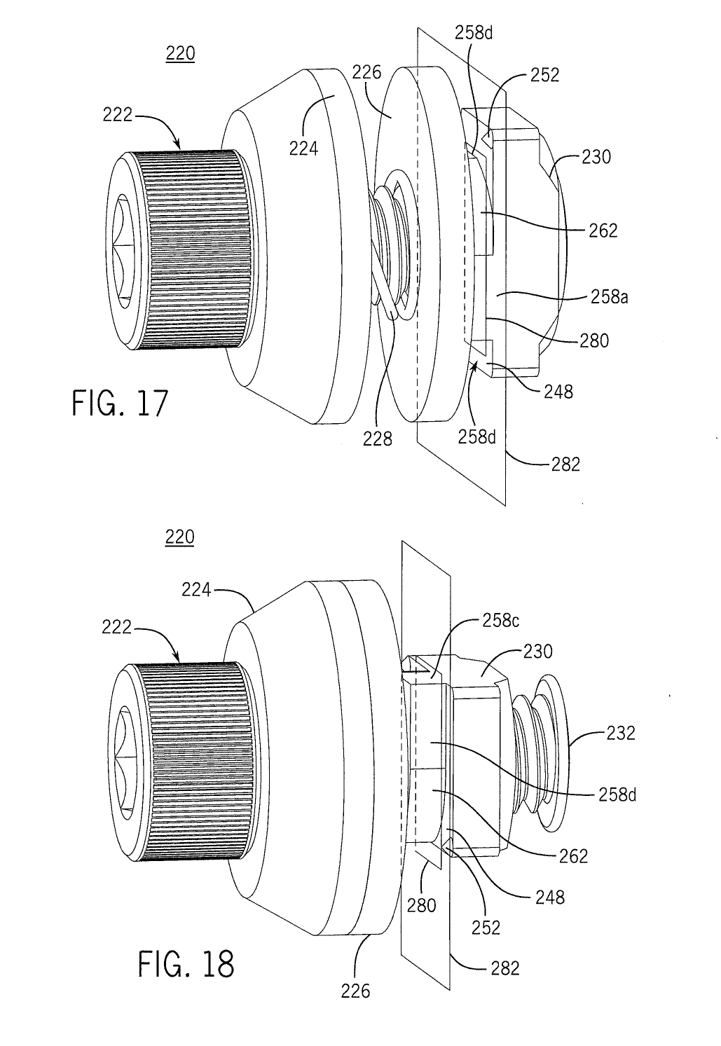

FIG. 17 illustrates the fastener system 220 in an assembled configuration. To assemble the fastener system 220, the screw 222 can be inserted through the washers 224 and 226, spring 228, and nut 230, and the peened contour 232 then formed to retain the various components on the screw 222. Contact of the head of the screw 222 with the front face 234 of the washer 224 also prevents retraction of the screw in the opposite direction, so that the fastener system 220 can be transported and installed as a single unitary assembly, rather than as loose individual parts. Further, due to its unitary assembly, the fastener system 220 can be installed onto an enclosure member without the need to access both sides of the member (e.g., without the need to access the interior of an enclosure).

In order for the fastener system 220 to secure a component to an enclosure (or other body), a generally rectangular mounting opening that is somewhat comparable in width to the nut 230 can be provided in both the enclosure and the component. In some embodiments, the relevant mounting opening may have a height that is similar to the height 246 of the nut 230. In some embodiments, the relevant mounting opening may have a somewhat smaller height than the height 246. As illustrated in FIG. 17, for example, a rectangular mounting opening 280 in an enclosure member 282 has a height that is somewhat smaller than the height 246 (see FIG. 15A) but somewhat larger than the height of the locking feature 250. Further, the mounting opening 280 has a width that is approximately equal to the width 244 of the nut 230. Accordingly, the fastener system 220 can be tilted upward or downward (not shown) in order to insert the nut 230 through the rectangular mounting opening 280, then returned to the perpendicular orientation (with respect to the mounting opening 280). In this way, the locking feature 250 can extend into the mounting opening 280, but the nut 230 can be generally prevented from passing entirely back through the mounting opening 280 by contact between the engagement surface 248 and the enclosure member 282.

With the fastener system 220 in a configuration similar to that illustrated in FIG. 17, the spring 228 can usefully serve to hold the fastener system 220 in place, by pressing against the washer 226 and thereby causing the enclosure member 282 to be gripped between the washer 226 and the nut 230. The curved transition regions 262 can also be useful in this regard, by assisting an operator in aligning the locking feature 250 with, and guiding the locking feature 250 into, the mounting opening 280.

A similarly scaled mounting opening can also be provided in another component (not shown) that is to be mounted to the enclosure member 282. The component to be mounted can then be disposed between the enclosure member 282 and the washer 226, with the nut 230 generally opposite the component (and the enclosure member 282) from the washer 226. Installation of the fastener system 220 into the component mounting opening of the component can then proceed similarly to (and at generally the same time as) the procedure discussed above for the mounting opening 280, with the nut inserted in turn through the mounting opening of the component to be mounted and then the mounting opening 280 of the enclosure member 292 (or vice versa).

With the fastener system 220 inserted through the mounting opening 280, the screw 222 can be rotated clockwise (i.e., tightened). As the screw is initially tightened, the nylon patch 222a engages the threaded bore 260 to cause the nut 230 also to rotate. Accordingly, the nut 230 can be rotated within the mounting opening 280 until one or more of the contact regions 258 contacts a corresponding one or more sides of the mounting opening 280 and prevents further rotation of the nut 230 in that direction. Alternatively, the entire fastener system 220 can be rotated (e.g., rather than rotating only the screw 222), to similar effect. In either case, the curved transition regions 262 of the nut 230 can assist an operator in smoothly rotating the locking feature 250 within the mounting opening 280 until the contact regions 258 appropriately engage the sides of the mounting opening 280.

As illustrated in FIG. 18, with the locking feature 250 of the nut 230 seated within the mounting opening 280, the nut 230 can be rotated such that the contact regions 258d and 258b (contact region 258b not shown in FIG. 18) contact the sides of the mounting opening 280. Rotation of the screw 222 can then drive the screw 222 through the nut 230 to generally compress the fastener system 220 (except for the screw 222). With appropriate tightening of the screw 222, the spring 228 can be fully compressed into the counterbore 242 of the washer 224 (see FIG. 16), the washer 226 urged directly against the washer 224, and the enclosure member 282 and the component to be mounted (not shown) clamped (directly or indirectly) between the engagement surface 248 of the nut 230 and the rear face of the washer 226. Accordingly, with sufficient tightening of the screw 222, the component to be mounted can be firmly held to the enclosure member 282 by the fastener system 220.

For convenience, the enclosure member 282 is shown with minimal thickness and the component is not illustrated. It will be understood, however, that different enclosure members and components may have different thicknesses. Usefully, because of the relatively large potential travel distance for the nut 230 along the screw 222, a large variety of thicknesses of components and enclosure members can be accommodated by the fastener system 220.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A fastener assembly for securing an object with a first mounting opening to a structure with a second mounting opening, the fastener assembly comprising:
a mounting cage with a cage portion and a flange attached to the cage portion at a first end of the cage portion, the cage portion including a first cage side with a first cage channel, and a second cage side with a first blocking feature;
a threaded fastener disposed through the cage portion; and
a nut that is elongate in a first dimension, the nut threadedly engaging the threaded fastener within the cage portion;
the fastener assembly having an installation configuration in which the nut is in a first orientation so that the first blocking feature blocks translation of the nut along the cage portion towards the flange and the cage portion is insertable through both the first mounting opening in the object and the second mounting opening in the structure; and
the fastener assembly having a fastening configuration in which the nut is rotated from the first orientation to a second orientation so that the nut is clear of the blocking feature and rotation of the threaded fastener translates the nut along the first cage channel towards the flange and clamps the object and the structure between the flange and the nut.

2. The fastener assembly of claim 1, wherein, when fastener assembly is in the installation configuration, the nut is disposed with a nut perimeter of the nut substantially within a cage perimeter of the cage portion; and
wherein, when the fastener assembly is in the fastening configuration, the nut is disposed with the nut perimeter least partly outside of the cage perimeter.

3. The fastener assembly of claim 1, wherein the cage portion further includes a back cage wall disposed opposite the flange, and a first strut connecting a first wall of the second cage side to the back cage wall to define a first insertion opening on the second cage side.

4. The fastener assembly of claim 3, wherein the first strut includes a beveled strut surface facing an internal area of the cage portion.

5. The fastener assembly of claim 4, wherein the nut includes a beveled nut surface on at least one corner of the nut, the beveled nut surface facing the beveled strut surface when the fastener assembly is in the installation configuration.

6. The fastener assembly of claim 5, wherein the beveled nut surface and the beveled strut surface provide clearance for the nut to rotate to clear the first blocking feature, as the fastener assembly is moved from the installation configuration to the fastening configuration.

7. The fastener assembly of claim 3, wherein the first blocking feature includes a side wall of the first insertion opening; and
wherein, when the fastener assembly is in the installation configuration, the nut extends along the first dimension at least partly into the first insertion opening so that translation of the nut along the cage portion towards the flange is blocked by the side wall of the first insertion opening.

8. The fastener assembly of claim 1, wherein the cage portion further includes a back cage wall disposed opposite the flange, the back cage wall being a substantially solid wall with a central aperture that receives an end of the threaded fastener; and
wherein the end of the threaded fastener exhibits a larger radius than a body of the threaded fastener to prevent passage of the end of the threaded fastener through the central aperture of the back cage wall.

9. The fastener assembly of claim 1, wherein the cage portion of the mounting cage further includes a third cage side with a second cage channel; and
wherein, when the fastener assembly is in the fastening configuration, the nut extends along the first direction at least partly into the second cage channel, so that the rotation of the threaded fastener translates the nut along the second cage channel towards the flange.

10. The fastener assembly of claim 9, wherein the cage portion of the mounting cage further includes a fourth cage side with a second blocking feature; and
wherein, when the fastener assembly is in the installation configuration, the second blocking feature blocks translation of the nut along the cage portion towards the flange.

11. The fastener assembly of claim 1, wherein the cage portion defines a cage perimeter that is elongate in a direction perpendicular to the second cage side.

12. The fastener assembly of claim 1, wherein the threaded fastener includes a non-threaded portion that overlaps with internal threads of the nut when the fastener assembly is in the installation configuration.

13. The fastener assembly of claim 1, wherein the cage portion further includes a back cage wall disposed opposite the flange; and
wherein the first cage channel extends from the flange to the back cage wall.

14. A fastener system, for use with a nut that has a nut width and a nut height larger than the nut width, to secure an object that has a first mounting opening to a structure that has a second mounting opening, the fastener system comprising:
a mounting cage with a flange and a cage portion;
the cage portion having a blocking feature, a first cage side with a first insertion opening, and a second cage side with a cage channel;
the first insertion opening being sized for the nut to be inserted through the first insertion opening into the cage portion with the nut in a first orientation;
the blocking feature blocking translation of the nut along the cage portion towards the flange, when the nut is in the first orientation; and
the cage channel guiding translation of the nut along the cage portion towards the flange, when the nut is rotated to a second orientation different from the first orientation.

15. The fastener system of claim 14, wherein the cage portion further includes a third cage side with a second insertion opening, with the third cage side being opposite the first cage side;
wherein, with the nut in the first orientation, the nut extends along the nut height between the first insertion opening and the second insertion opening; and
wherein, with the nut in the second orientation, the nut extends along the nut height through the cage channel beyond a cage perimeter of the cage portion.

16. The fastener system of claim 14, wherein the first cage side includes a first wall connected to the flange, and a first strut that is connected to the first wall and at least partly defines the first insertion opening.

17. The fastener system of claim 16, wherein the first insertion opening opens into the cage channel.

18. A method for securing an object to a structure using a cage nut assembly, the object including a first mounting opening, the structure including a second mounting opening aligned with the first mounting opening, and the cage nut assembly including a threaded fastener, a nut, and a mounting cage, with the mounting cage including a flange and a cage portion with a blocking feature, and with the threaded fastener, the mounting cage, and the nut being initially assembled into a unitary assembly with an insertion configuration in which the threaded fastener extends through the flange to engage the nut, a perimeter of the nut is disposed substantially within a perimeter of the cage portion, and the blocking feature blocks the nut from translating along the cage portion towards the flange, the method comprising:
inserting the unitary assembly into the first mounting opening and the second mounting opening, with the unitary assembly in the insertion configuration, until the nut and a part of the cage portion are disposed on a first side of the object and the structure, and the flange is disposed on a second side of the object and the structure;
rotating the threaded fastener from the first side of the object and the structure to rotate the nut so that the perimeter of the nut extends outside the perimeter of the cage and the nut is moved clear of the blocking feature; and
further rotating the threaded fastener to translate the nut along the cage towards the flange until the object and the structure are clamped between the nut and the flange.

19. The method of claim 18, with the nut being elongate in a first dimension, with the cage portion of the mounting cage including a first cage side with a first cage channel, and a second cage side that includes the first blocking feature and a first strut, wherein rotating the threaded fastener to rotate the nut includes rotating the threaded fastener to rotate the nut in a first direction until the first strut blocks further rotation of the nut in the first direction.

20. The method of claim 19, wherein, when the first strut blocks further rotation of the nut in the first direction, the nut extends along the first dimension at least partly through the first cage side; and
wherein further rotating the threaded fastener to translate the nut along the cage towards the flange causes the nut to translate along the first cage channel.
